(19) United States
(12) Patent Application Publication
(10) Pub. No.: US 2026/0088528 A1
(43) Pub. Date: Mar. 26, 2026

(54) CONNECTOR

(71) Applicant: SUMITOMO WIRING SYSTEMS, LTD., Mie (JP)

(72) Inventor: Tomoki MATSUZAKA, Mie (JP)

(21) Appl. No.: 19/328,596

(22) Filed: Sep. 15, 2025

(30) Foreign Application Priority Data
Sep. 20, 2024 (JP) 2024-163937

(51) Int. Cl. H01R 9/22; H01R 4/30; H01R 9/18; H01R 9/24; H01R 11/12

(52) U.S. Cl. CPC H01R 9/223; H01R 4/30; H01R 9/18; H01R 9/2491; H01R 11/12; H01R 2201/26

(57) ABSTRACT

A connector includes a housing including a housing body and a retainer mounted on the housing body and a tubular first terminal accommodating portion provided in the housing body. The connector includes a first terminal for signal line to be inserted into the first terminal accommodating portion along a first direction, a connection terminal screw-fastened to the first terminal and a wire electrically connected to the connection terminal. The first terminal is structured such that a first connecting portion connected to the connection terminal and a second connecting portion to be connected to a mating terminal are provided side by side along the first direction. The connection terminal is structured such that a terminal connecting portion connected to the first connecting portion and a wire connecting portion connected to the wire are provided side by side along an orthogonal direction orthogonal to the first direction.

### CROSS-REFERENCE TO RELATED APPLICATIONS

This application is based on and claims priority from Japanese Patent Application No. 2024-163937, filed on Sep. 20, 2024, with the Japan Patent Office, the disclosure of which is incorporated herein in its entirety by reference.

### TECHNICAL FIELD

The present invention relates to a connector.

### BACKGROUND

Conventionally, a connector to be installed in a vehicle is provided with a housing, a terminal held in the housing and a wire connected to the terminal (see, for example, Japanese Patent Laid-open Publication No. 2017-208248). The housing includes a housing body and a retainer mounted on the housing body. In the connector of this type, a part of the terminal is sandwiched and held by the retainer and the housing body by assembling the retainer with the housing body.

### SUMMARY

A size reduction is desired for the above connector.

The present disclosure aims to provide a connector reducible in size.

The present disclosure is directed to a connector with a housing including a housing body and a retainer mounted on the housing body, a tubular first terminal accommodating portion provided in the housing body, a first terminal for signal line to be inserted into the first terminal accommodating portion along a first direction, a connection terminal screw-fastened to the first terminal, and a wire electrically connected to the connection terminal, the first terminal being structured such that a first connecting portion connected to the connection terminal and a second connecting portion to be connected to a mating terminal are provided side by side along the first direction, and the connection terminal being structured such that a terminal connecting portion connected to the first connecting portion and a wire connecting portion connected to the wire are provided side by side along an orthogonal direction orthogonal to the first direction.

According to the connector of the present disclosure, an effect of enabling a size reduction is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram showing a vehicle in which a connector of one embodiment is installed.

FIG. 2 is a perspective view showing the connector of the embodiment.

FIG. 3 is an exploded perspective view showing the connector of the embodiment.

FIG. 4 is an exploded perspective view showing the connector of the embodiment.

FIG. 5 is a plan view showing the connector of the embodiment.

FIG. 6 is a section (section along 6-6 in FIG. 5) showing the connector of the embodiment.

FIG. 7 is a perspective view in section showing the connector of the embodiment.

FIG. 8 is a plan view enlargedly showing a part of the connector of the embodiment.

FIG. 9 is a section (section along 9-9 in FIG. 8) enlargedly showing a part of the connector of the embodiment.

FIG. 10 is a perspective view showing a first terminal, a connection terminal, a wire and a nut of the embodiment.

FIG. 11 is an exploded perspective view showing the first terminal, the connection terminal, the wire and the nut of the embodiment.

FIG. 12 is a perspective view showing a retainer of the embodiment.

FIG. 13 is an exploded perspective view showing a first terminal, a connection terminal, a wire and a nut of a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The connector of the present disclosure is provided with a housing including a housing body and a retainer mounted on the housing body, a tubular first terminal accommodating portion provided in the housing body, a first terminal for signal line to be inserted into the first terminal accommodating portion along a first direction, a connection terminal screw-fastened to the first terminal, and a wire electrically connected to the connection terminal, the first terminal being structured such that a first connecting portion connected to the connection terminal and a second connecting portion to be connected to a mating terminal are provided side by side along the first direction, and the connection terminal being structured such that a terminal connecting portion connected to the first connecting portion and a wire connecting portion connected to the wire are provided side by side along an orthogonal direction orthogonal to the first direction.

According to this configuration, the terminal connecting portion of the connection terminal is screw-fastened to the first connecting portion of the first terminal, and the terminal connecting portion and the wire connecting portion are provided side by side along the orthogonal direction orthogonal to the first direction. The wire is connected to the wire connecting portion. In this way, the wire can be electrically connected to the first connecting portion of the first terminal through the connection terminal. Further, since the wire is connected to the wire connecting portion provided side by side with the terminal connecting portion in the orthogonal direction, that wire can be routed to extend in the orthogonal direction orthogonal to an insertion direction of the first terminal into the first terminal accommodating portion (i.e. the first direction). In this way, the enlargement of the first terminal and the wire in the first direction and a first opposite direction can be suppressed. Thus, the connector can be reduced in size in the first direction and the first opposite direction, for example, as compared to the case where a wire directly connected to the first connecting portion is routed to extend in the first opposite direction opposite to the first direction.
[2] In [1] described above, the first connecting portion may include a base portion and a bolt portion projecting in a first opposite direction opposite to the first direction from the base portion, the terminal connecting portion may include a body portion and a bolt hole penetrating through the body portion in the first direction, and the terminal connecting portion may be electrically connected to the first connecting portion by fastening a nut to the bolt portion inserted through the bolt hole.

According to this configuration, the terminal connecting portion and the first connecting portion can be electrically connected to each other by bolt-nut fastening using the bolt portion of the first connecting portion and the nut. Further, since the first connecting portion is provided with the bolt portion, it can be suppressed that a transverse cross-sectional area of the first connecting portion, i.e. a conductor cross-sectional area of the first connecting portion, is reduced. That is, a reduction in the conductor cross-sectional area of the first connecting portion can be suppressed as compared to the case where a bolt hole, through which a bolt is inserted, is formed in the first connecting portion.

[3] In [2] described above, the terminal connecting portion may include a projecting piece projecting outward from an outer peripheral surface of the body portion, the retainer may be assembled with the housing body along the first direction, the retainer may include a terminal holding portion for holding the first terminal, the terminal holding portion may include a tubular portion to be fit into the first terminal accommodating portion and a pressing portion projecting further in the first direction than an end surface in the first direction of the tubular portion and capable of contacting the projecting piece, and the projecting piece may be sandwiched by the housing body and the pressing portion in the first direction.

According to this configuration, the projecting piece of the terminal connecting portion is sandwiched and held by the housing body and the pressing portion of the retainer in the first direction. Movements of the projecting piece in the first direction and the first opposite direction can be suitably restricted by these housing body and pressing portion. As a result, position shifts of the connection terminal including the projecting piece and the first terminal connected to the connection terminal in the first direction and the first opposite direction can be suitably suppressed. Further, by providing the projecting piece, the enlargement of the entire terminal connecting portion can be suppressed. In this way, a reduction in separation distance to an adjacent terminal can be suppressed.
[4] In [3] described above, the first terminal accommodating portion may include a recess recessed in the first direction from an end surface in the first opposite direction of the first terminal accommodating portion, the projecting piece may be insertable into the recess along the first direction, the pressing portion may be insertable into the recess along the first direction, and the projecting piece may be sandwiched by a bottom surface of the recess and the pressing portion in the first direction.

According to this configuration, the projecting piece of the terminal connecting portion is sandwiched and held by the bottom surface of the recess and the pressing portion of the retainer in the first direction. Movements of the projecting piece in the first direction and the first opposite direction can be suitably restricted by the bottom surface of the recess and the pressing portion. As a result, position shifts of the connection terminal and the first terminal in the first direction and the first opposite direction can be suitably suppressed.
[5] In [3] or [4] described above, the terminal connecting portion may include at least two projecting pieces, the bolt hole may be provided in a center of the body portion in a plan view in the first direction, and the two projecting pieces may be provided on both sides of the bolt hole and project in directions opposite to each other.

According to this configuration, each of the two projecting pieces provided on the both sides of the bolt hole provided in the center of the body portion is sandwiched and held by the housing body and the pressing portion of the retainer. In this way, movements of the two projecting pieces in the first direction and the first opposite direction can be suitably restricted. Therefore, movements of the connection terminal including the two projecting pieces in the first direction and the first opposite direction can be stably restricted.
[6] In any one of [3] to [5] described above, the body portion may be formed to have a circular planar shape when viewed in the first direction, and the projecting piece may be formed to project radially outwardly of the body portion from the outer peripheral surface of the body portion.

According to this configuration, the first connecting portion of the first terminal and the wire can be electrically connected to each other through the connection terminal, which is a round terminal. Further, the enlargement of the entire terminal connecting portion in a radial direction can be suppressed by providing the projecting piece.
[7] In any one of [1] to [6] described above, the housing body may include a wire accommodating portion for accommodating the wire, the wire accommodating portion may be formed to communicate with the first terminal accommodating portion, the wire accommodating portion may include a wire holding projection projecting inward from an inner surface of the wire accommodating portion, and a width of the wire accommodating portion in a part formed with the wire holding projection may be smaller than an outer diameter of the wire.

According to this configuration, the wire is press-fit into the wire accommodating portion in the part formed with the wire holding projection. In this way, a movement of the wire inside the wire accommodating portion can be suitably restricted.
[8] In any one of [1] to [7] described above, the connector may be provided with a tubular second terminal accommodating portion provided in the housing body, a second terminal for power line to be inserted into the second terminal accommodating portion along the first direction, and a busbar electrically connected to the second terminal, and the first terminal may be provided at a position overlapping the busbar in a plan view in the first direction.

According to this configuration, the first terminal is provided to overlap the busbar to be connected to the second terminal in the plan view in the first direction. At this time, since the enlargement of the first terminal and the wire in the first direction and the first opposite direction can be suppressed, the interference of the first terminal and the wire with the busbar can be suitably suppressed.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure. “Orthogonal” in this specification means not only strictly orthogonal, but also substantially orthogonal within a range in which functions and effects in this embodiment are achieved. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Note that “tubular” shapes include circular shapes, elliptical shapes and polygonal shapes with angular or round corners, but there is no limitation to these. Further, a term “annular” used in the description of this specification indicates an arbitrary structure forming a loop or a continuous shape having no end part. Note that “annular shapes” include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two part. Further, terms such as “first”, “second”, “third” and “fourth” in this specification are merely used to distinguish objects and do not rank the objects. Note that the present invention is not limited to these illustrations, but is represented by claims and intended to include all changes in the scope of claims and in the meaning and scope of equivalents.

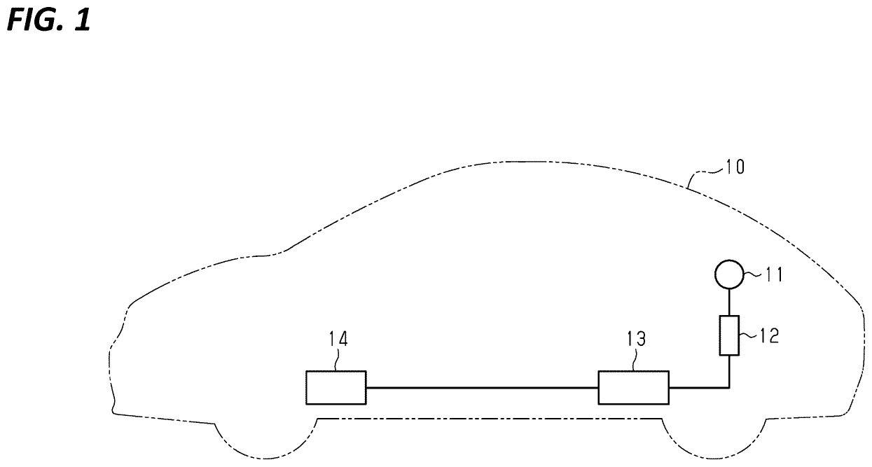

As shown in FIG. 1, a vehicle 10 includes a charging inlet 11, a charger 12, a battery 13 and a power control unit 14. The vehicle 10 is, for example, an electric vehicle or a plug-in hybrid vehicle.

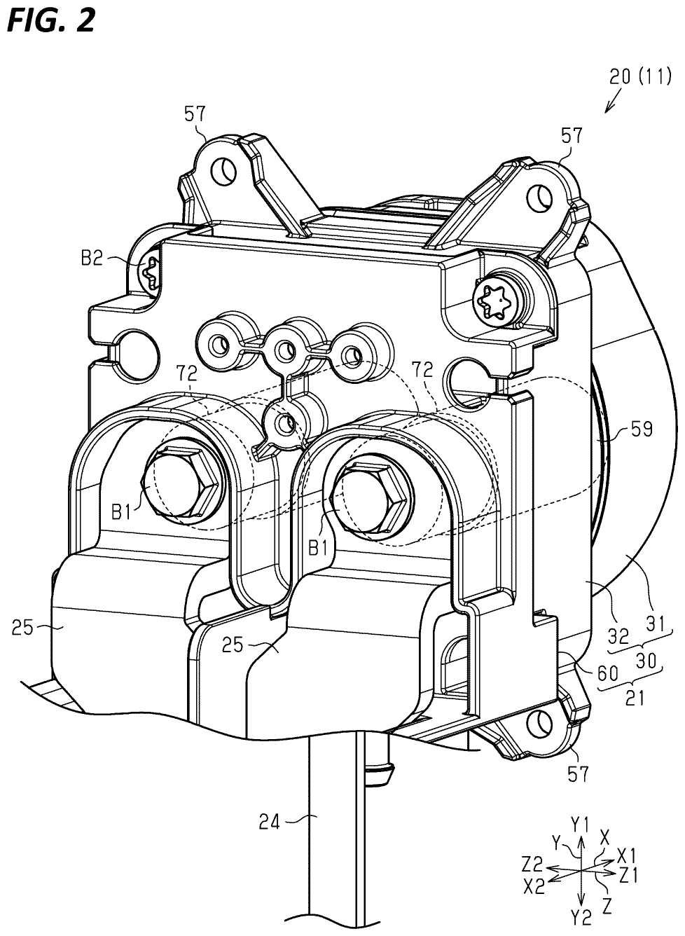

The charging inlet 11 is connectable to an external connector connected to an unillustrated external power supply. The charging inlet 11 includes a connector 20 shown in FIG. 2. The charger 12 is connected to the charging inlet 11 and the battery 13. For example, the charger 12 converts alternating-current power supplied from the charging inlet 11 into direct-current power and supplies the converted direct-current power to the battery 13. The battery 13 is, for example, a secondary battery such as a lithium-ion battery. The power control unit 14 includes an inverter and a converter. The power control unit 14 controls, for example, an unillustrated motor generator for driving wheels.

### Configuration of Connector

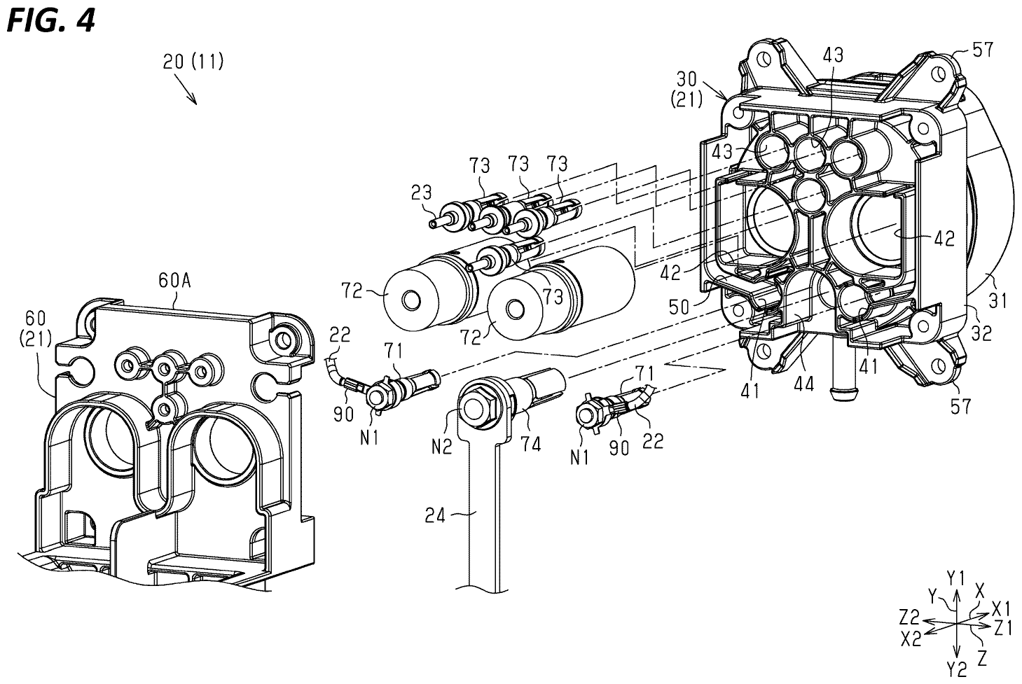

As shown in FIGS. 2 to 4, the connector 20 includes a housing 21 and a terminal group held in the housing 21. As shown in FIG. 4, the terminal group includes one or more (two in this embodiment) first terminals 71, one or more (two in this embodiment) second terminals 72, one or more (fourth in this embodiment) third terminals 73 and one or more (one in this embodiment) fourth terminal 74. The connector 20 includes two wires 22 respectively connected to the two first terminals 71, four wires 23 respectively connected to the four third terminals 74 and a busbar 24 electrically connected to the fourth terminal 74. As shown in FIG. 2, the connector 20 includes busbars 25 electrically connected to the second terminals 72.

Note that a first axis X, a second axis orthogonal to the first axis X and a third axis Z orthogonal to both the first and second axes X, Y are shown in each of FIG. 2 and subsequent figures. Further, in each of FIG. 2 and subsequent figures, a first direction X1, which is one direction along the first axis X, and a first opposite direction X2, which is another direction along the first axis X and a direction opposite to the first direction X1, are shown. In each of FIG. 2 and subsequent figures, a second direction Y1, which is one direction along the second axis Y, and a second opposite direction Y2, which is another direction along the second axis Y and a direction opposite to the second direction Y1, are shown. In each of FIG. 2 and subsequent figures, a third direction Z1, which is one direction along the third axis Z, and a third opposite direction Z2, which is another direction along the third axis Z and a direction opposite to the third direction Z1, are shown. Note that each direction in each of FIG. 2 and subsequent figures does not necessarily indicate a posture during the use of the connector 20.

The housing 21 includes a housing body 30 and a retainer 60 mounted on the housing body 30. Each of the housing body 30 and the retainer 60 is, for example, made of synthetic resin. The retainer 60 is a component separate from the housing body 30.

### Configuration of Housing Body 30

The housing body 30 includes a connector fitting portion 31 and a mounting portion 32, on which the retainer 60 is to be mounted. The aforementioned external connector is fit into the connector fitting portion 31.

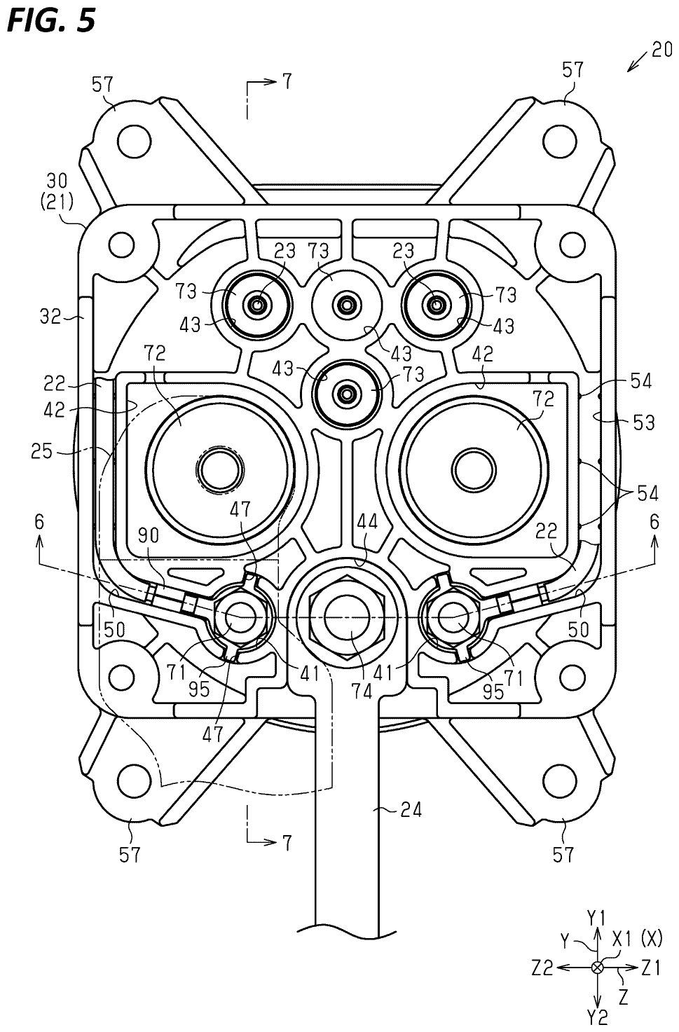

As shown in FIGS. 4 and 5, the housing body 30 includes two first terminal accommodating portions 41 for individually accommodating the two first terminals 71 and two second terminal accommodating portions 42 for individually accommodating the two second terminals 72. The housing body 30 includes four third terminal accommodating portions 43 for individually accommodating the four third terminals 73 and one fourth terminal accommodating portion 44 for accommodating the one fourth terminal 74. Each of the first terminal accommodating portions 41, the second terminal accommodating portions 42, the third terminal accommodating portions 43 and the fourth terminal accommodating portion 44 is formed into a tubular shape as a whole.

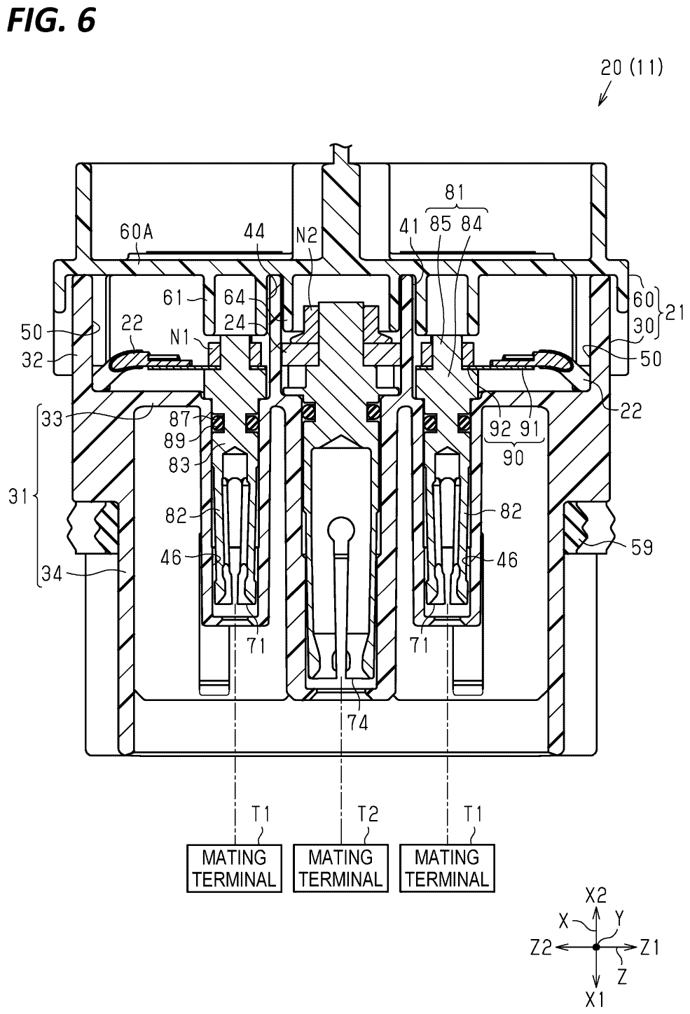

As shown in FIG. 6, the connector fitting portion 31 is provided with a back wall 33 and a tubular receptacle 34 projecting in the first direction X1 from the peripheral edge of the back wall 33. The back wall 33 is, for example, formed into a disk shape. The receptacle 34 is open in the first direction X1.

The mounting portion 32 projects in the first opposite direction X2 from the back wall 33. The mounting portion 32 is formed into a rectangular tube shape as a whole. The mounting portion 32 is open in the first opposite direction X2.

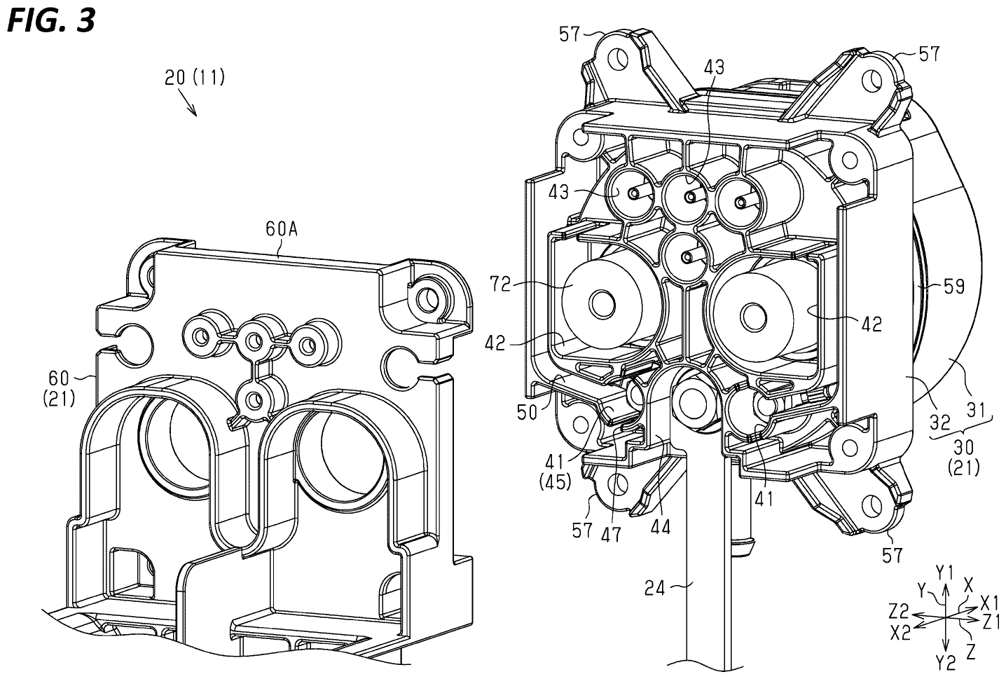

As shown in FIG. 3, each first terminal accommodating portion 41 is formed to have a circular planar shape as a whole when viewed in the first direction X1. Each first terminal accommodating portion 41 is formed into a hollow cylindrical shape as a whole.

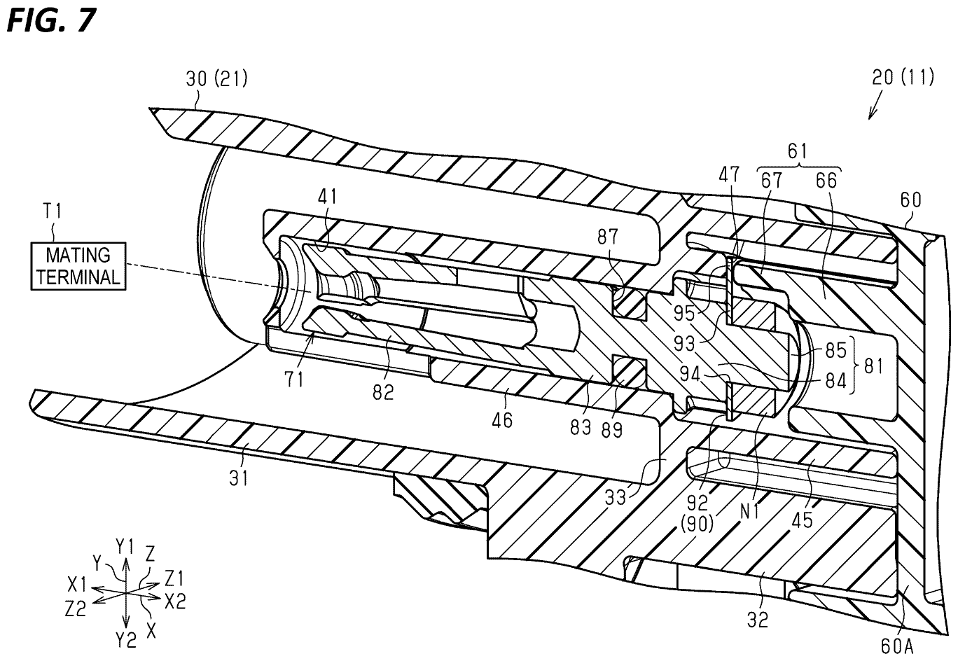

As shown in FIG. 7, each first terminal accommodating portion 41 includes a first accommodation tube portion 45 and a second accommodation tube portion 46. The first accommodation tube portion 45 projects in the first opposite direction X2 from the back wall 33. The first accommodation tube portion 45 is arranged inside the mounting portion 32. The second accommodation tube portion 46 projects in the first direction X1 from the back wall 33. The second accommodation tube portion 46 is arranged inside the connector fitting portion 31. An internal space of the second accommodation tube portion 46 communicates with that of the first accommodation tube portion 45. An outer diameter of the second accommodation tube portion 46 is smaller than that of the first accommodation tube portion 45. An inner diameter of the second accommodation tube portion 46 is smaller than that of the first accommodation tube portion 45.

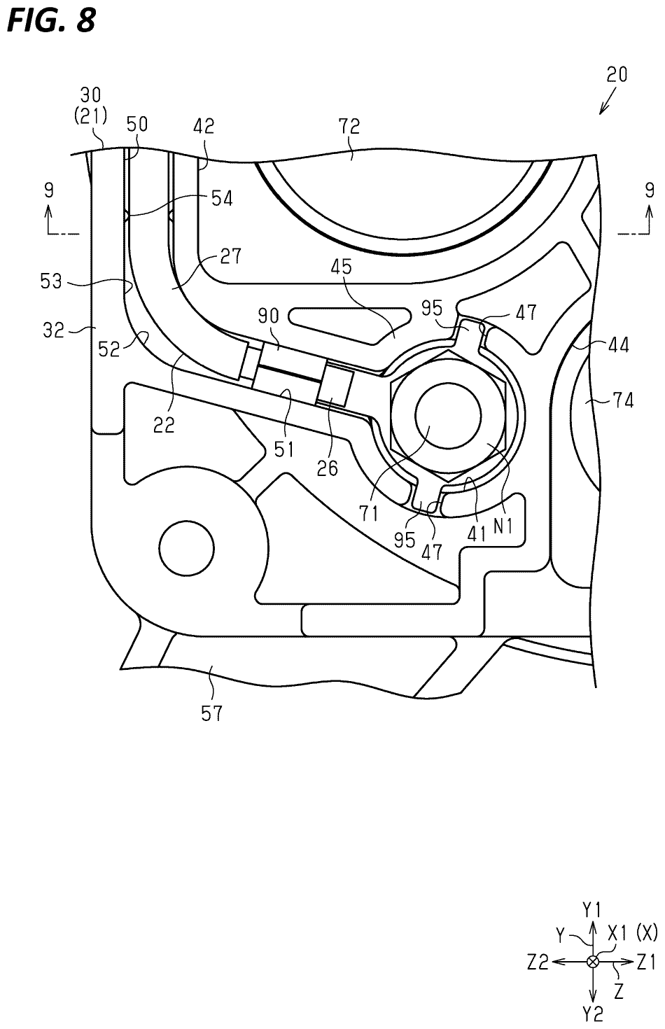

As shown in FIG. 8, two recesses 47 are provided in the first accommodation tube portion 45 of the first terminal accommodating portion 41. The two recesses 47 are provided at an interval from each other in a circumferential direction of the first accommodation tube portion 45. Each recess 47 is formed to allow communication between the inside and outside of the first accommodation tube portion 45. Each recess 47 is formed to be open radially inwardly of the first accommodation tube portion 45 and open radially outwardly of the first accommodation tube portion 45. As shown in FIG. 3, each recess 47 is formed to be recessed in the first direction X1 from an end surface in the first opposite direction X2 of the first accommodation tube portion 45. Each recess 47 is formed by cutting an end part in the first opposite direction X2 of the first accommodation tube portion 45. As shown in FIG. 7, an end surface of each recess 47 facing in the first opposite direction X2, i.e. the bottom surface of each recess 47, is provided at a position further in the first opposite direction X2 than an end surface in the first opposite direction X2 of the back wall 33.

Note that, although not described in detail, each of the second terminal accommodating portions 42, the third terminal accommodating portions 43 and the fourth terminal accommodating portion 44 shown in FIG. 4 includes an accommodation tube portion arranged inside the connector fitting portion 31 and an accommodation tube portion arranged inside the mounting portion 32, similarly to the first terminal accommodating portions 41.

As shown in FIG. 5, the housing body 30 includes two wire accommodating portions 50 for individually accommodating the two wires 22. Each wire accommodating portion 50 communicates with the first terminal accommodating portion 41. As shown in FIG. 8, each wire accommodating portion 50 includes a first straight portion 51, a bent portion 52 and a second straight portion 53. The first straight portion 51 extends straight along an oblique direction intersecting both the second and third axes Y, Z from the first terminal accommodating portion 41 in a plan view in the first direction X1. The bent portion 52 is provided between the first and second straight portions 51, 53. The second straight portion 53 extends straight in the second direction Y1 from the bent portion 52.

As shown in FIG. 5, each wire accommodating portion 50 includes one or more (three in this embodiment) wire holding projections 54. The three wire holding projections 54 are provided in the second straight portion 53. The three wire holding projections 54 are provided at intervals from each other along the second axis Y.

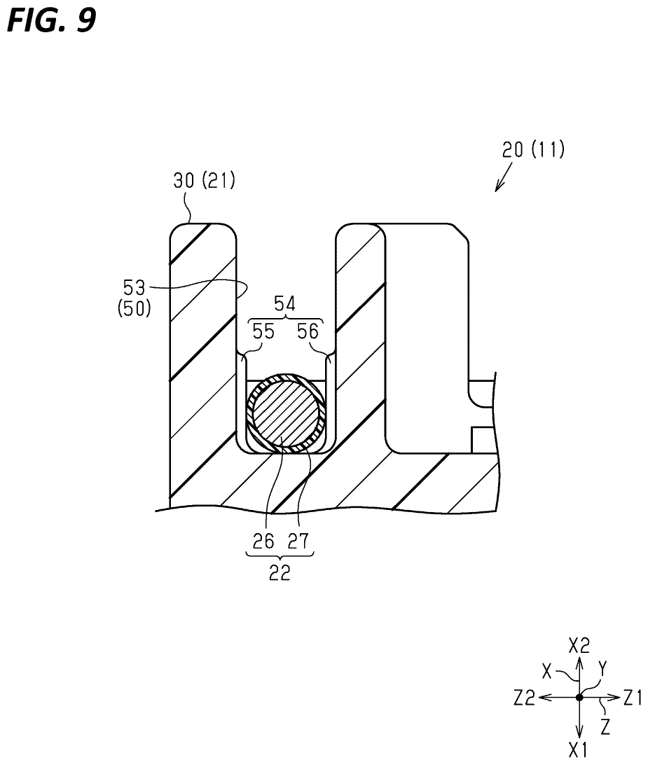

As shown in FIG. 9, each wire holding projection 54 is formed to project inwardly of the wire accommodating portion 50 from inner surfaces of the wire accommodating portion 50. Each wire holding projection 54 includes a first projection 55 projecting in the third direction Z1 from the inner surface of the wire accommodating portion 50 facing in the third direction Z1 and a second projection 56 projecting in the third opposite direction Z1 from the inner surface of the wire accommodating portion 50 facing in the third opposite direction Z2. The first and second projections 55, 56 are provided to face each other in the third axis Z. A separation distance along the third axis Z between the first and second projections 55, 56 is smaller than an outer diameter of the wire 22. That is, a width of the wire accommodating portion 50 in a part formed with the wire holding projection 54 is smaller than the outer diameter of the wire 22. The wire 22 is press-fit (specifically, lightly press-fit) between the first and second projections 55, 56. Each wire holding projection 54 is provided on an end part in the first direction X1 of the wire accommodating portion 50 in the first axis X. In other words, each wire holding projection 54 is formed to extend in the first opposite direction X2 from the bottom surface of the wire accommodating portion 50, i.e. the inner surface of the wire accommodating portion 50 facing in the first opposite direction X2.

As shown in FIG. 3, the housing body 30 includes one or more (four in this embodiment) attaching portions 57 to be attached to a vehicle body of the vehicle 10 (see FIG. 1). Each attaching portion 57 is formed to project outward from the outer periphery of the mounting portion 32.

As shown in FIG. 6, an annular sealing member 59 is mounted on the outer periphery of the receptacle 34 of the housing body 30. The sealing member 59 is formed to surround the receptacle 34 over an entire periphery in a circumferential direction. The sealing member 59 is, for example, made of rubber.

### Configuration of First Terminals 71

As shown in FIG. 4, the two first terminals 71 are provided on both sides of the fourth terminal 74 in the third axis Z. The two first terminals 71 are provided at positions further in the second opposite direction Y2 than the second terminals 72. The two first terminals 71 have the same structure. Each first terminal 71 is inserted into the first terminal accommodating portion 41 along the first direction X1. As shown in FIG. 5, each first terminal 71 is provided at a position overlapping the busbar 25 in a plan view in the first direction X1. Each first terminal 71 is a terminal for signal line.

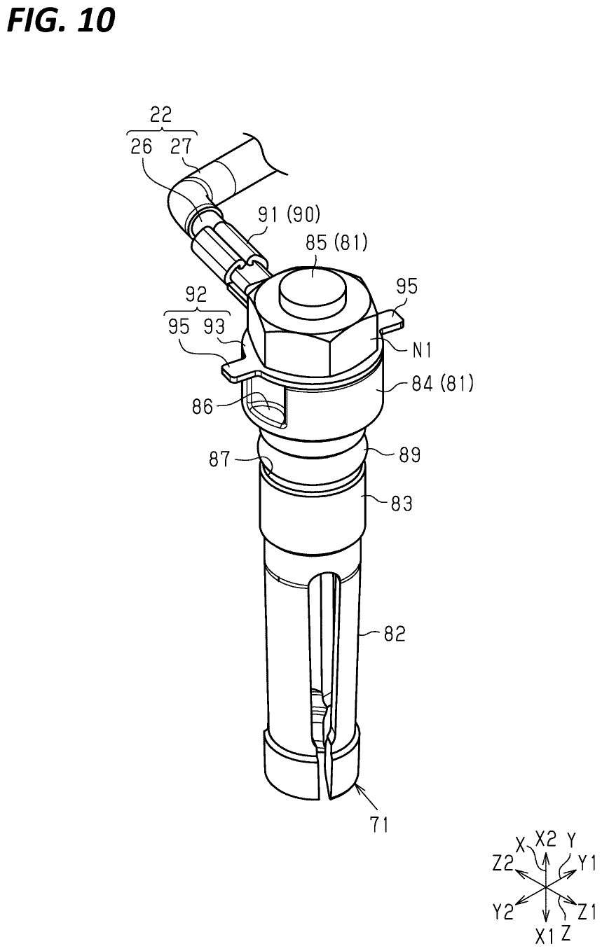

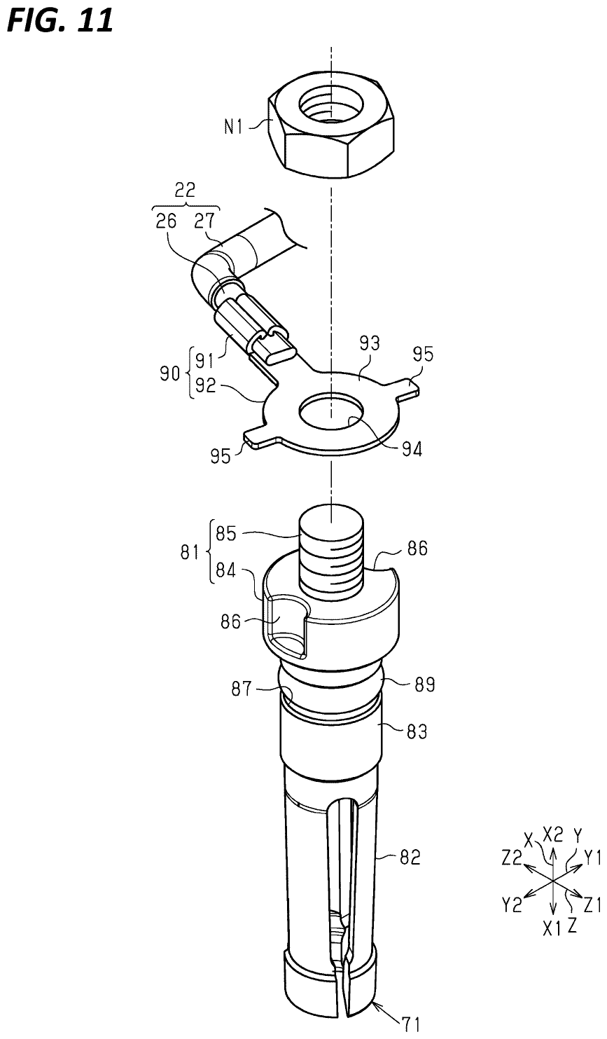

As shown in FIGS. 10 and 11, a connection terminal 90 made of metal and to be connected to the wire 22 is electrically connected to each first terminal 71. The connection terminal 90 is connected to each first terminal 71 by screw-fastening. The connection terminal 90 is connected to each first terminal 71 of this embodiment by bolt-nut fastening using a nut N1. Here, as shown in FIG. 11, the nut N1 is formed into an annular shape. The nut N1 is, for example, made of metal. An internal thread is formed on the inner peripheral surface of the nut N1.

Each first terminal 71 includes a first connecting portion 81, a second connecting portion 82 and a coupling portion 83 coupling those first and second connecting portions 81, 82. Each first terminal 71 is structured such that the first connecting portion 81, the coupling portion 83 and the second connecting portion 82 are provided side by side along the first direction X1. Each first terminal 71 is a single component in which the first connecting portion 81, the coupling portion 83 and the second connecting portion 82 are continuously and integrally formed. Each first terminal 71 is, for example, made of metal.

The first connecting portion 81 includes a base portion 84 and a bolt portion 85. The base portion 84 is formed into a cylindrical shape as a whole. An outer diameter of the base portion 84 is larger than that of the coupling portion 83. As shown in FIG. 7, the outer diameter of the base portion 84 is so set that the base portion 84 is insertable into the first accommodation tube portion 45, but not insertable into the second accommodation tube portion 46.

As shown in FIG. 11, the base portion 84 includes two cut portions 86. The two cut portions 86 are provided on both sides of the bolt portion 85 in a plan view in the first direction X1. Each cut portion 86 is formed by cutting the outer peripheral surface of the base portion 84. Each cut portion 86 is formed to be recessed in the first direction X1 from an end surface in the first opposite direction X2 of the base portion 84. The inner surface of each cut portion 86 is formed into an arcuately curved surface.

The bolt portion 85 is formed to project in the first opposite direction X2 from the end surface in the first opposite direction X2 of the base portion 84. The bolt portion 85 is formed into a cylindrical shape as a whole. An external thread engageable with the nut N1 for fastening is formed on the outer peripheral surface of the bolt portion 85. The external thread is formed to correspond to the internal thread formed on the inner peripheral surface of the nut N1.

The coupling portion 83 is formed into a cylindrical shape as a whole. As shown in FIG. 7, an accommodation groove 87 for accommodating a sealing member 89 is provided in the outer peripheral surface of the coupling portion 83. The accommodation groove 87 is formed to be recessed radially inwardly from the outer peripheral surface of the coupling portion 83. The accommodation groove 87 is continuously formed over the entire periphery of the coupling portion 83 in a circumferential direction.

The sealing member 89 is accommodated in the accommodation groove 87. The sealing member 89 is formed to surround the coupling portion 83 over an entire periphery in the circumferential direction. The sealing member 89 is formed into a circular annular shape. The sealing member 89 seals between the outer peripheral surface of the first terminal 71 and the inner peripheral surface of the first terminal accommodating portion 41. The sealing member 89 is, for example, made of rubber.

The second connecting portion 82 projects in the first direction X1 from the coupling portion 83. The second connecting portion 82 is formed into a tubular shape as a whole. The second connecting portion 82 is electrically connected to a mating terminal T1. The mating terminal T1 is, for example, a terminal of the external connector described above. By connecting the external connector to the charging inlet 11, the mating terminal T1 is connected to the second connecting portion 82 (see FIG. 6).

### Configurations of Wires 22 and Connection Terminals 90

As shown in FIG. 11, the wire 22 includes an electrically conductive core wire 26 and an insulation coating 27 covering the outer periphery of the core wire 26. The insulation coating 27 covers the outer peripheral surface of the core wire 26 over an entire periphery in a circumferential direction. An end part of the core wire 26 is exposed from the insulation coating 27.

The connection terminal 90 includes a wire connecting portion 91 to be connected to an end part of the wire 22 and a terminal connecting portion 92 to be connected to the first terminal 71. The connection terminal 90 is structured such that the wire connecting portion 91 and the terminal connecting portion 92 are provided side by side along an orthogonal direction orthogonal to the first direction X1. The connection terminal 90 is a single component in which the wire connecting portion 91 and the terminal connecting portion 92 are continuously and integrally formed. Note that the two connection terminals 90 shown in FIG. 4 have the same structure.

The wire connecting portion 91 is connected to the end part of the core wire 26 exposed from the insulation coating 27. The wire connecting portion 91 is connected to the core wire 26 by crimping, resistance welding or the like. The wire connecting portion 91 of this embodiment is connected to the core wire 26 by crimping. In this way, the wire connecting portion 91 and the core wire 26 are electrically and mechanically connected.

The terminal connecting portion 92 includes a body portion 93. The body portion 93 is in the form of a plate. The body portion 93 is formed to have a circular planar shape when viewed in the first direction X1 as a whole. The terminal connecting portion 92 includes a bolt hole 94 penetrating through the body portion 93 in the first direction X1. The bolt hole 94 is provided in a center of the body portion 93 in a plan view in the first direction X1.

The terminal connecting portion 92 includes one or more (two in this embodiment) projecting pieces 95 projecting outward from the outer peripheral surface of the body portion 93. The two projecting pieces 95 are provided at an interval from each other in a circumferential direction of the body portion 93. The two projecting pieces 95 are provided on the both sides of the bolt hole 94. The two projecting pieces 95 project in directions opposite to each other. Each projecting piece 95 projects further outward than the outer peripheral surface of the base portion 84. Each projecting piece 95 is in the form of a plate. Each projecting piece 95 is formed to have a rectangular planar shape when viewed in the first direction X1 as a whole. Each projecting piece 95 is insertable into the recess 47 (see FIG. 7) of the first terminal accommodating portion 41 along the first direction X1.

The terminal connecting portion 92 is connected to the first connecting portion 81 of the first terminal 71. The terminal connecting portion 92 is electrically and mechanically connected to the first connecting portion 81 by fastening the nut N1 to the bolt portion 85 inserted through the bolt hole 94. That is, the terminal connecting portion 92 is electrically connected to the first connecting portion 81 by bolt-nut fastening using the bolt portion 85 and the nut N1. Note that, at the time of bolt-nut fastening, the two cut portions 86 are clamped by a jig to restrict the rotation of the first terminal 71, whereby the co-rotation of the bolt portion 85 and the nut N1 can be suppressed. As shown in FIG. 7, with the terminal connecting portion 92 and the first connecting portion 81 fastened by the bolt and the nut, an end surface in the first direction X1 of the body portion 93 is in contact with the end surface in the first opposite direction X2 of the base portion 84.

The first terminal 71 connected to the connection terminal 90 is inserted into the first terminal accommodating portion 41 along the first direction X1. At this time, the base portion 84 of the first connecting portion 81 is formed in a size not to be insertable into the second accommodation tube portion 46 of the base portion 84. In this way, the end surface in the first direction X1 of the base portion 84 is held in contact with the end surface in the first opposite direction X2 of the back wall 33. Further, the projecting pieces 95 of the connection terminal 90 are held in contact with the bottom surfaces of the recesses 47 of the first terminal accommodating portion 41. By these, an insertion amount of the first terminal 71 into the first terminal accommodating portion 41 is restricted.

### Configuration of Second Terminals 72

As shown in FIG. 4, the two second terminals 72 are provided between the first terminals 71 and the third terminals 73 in the second axis Y. Each second terminal 72 is a terminal for power line. Each second terminal 72 is a terminal compatible with a high-voltage power supply. Each second terminal 72 is formed to be thicker in diameter than each first terminal 71. Each second terminal 72 is accommodated into the second terminal accommodating portion 42 of the housing body 30 along the first direction X1. One of the two second terminals 72 is a positive-side terminal, and the other is a negative-side terminal. With the aforementioned external connector connected to the charging inlet 11, each second terminal 72 is electrically connected to the external power supply. A current is supplied to the second terminal 72 from the external power supply.

As shown in FIG. 2, the busbar 25 is electrically connected to each second terminal 72. The busbar 25 is connected to each second terminal 72 by screw fastening using a bolt B1. The busbar 25 is accommodated in the retainer 60. The busbar 25 extends in the second opposite direction Y2 from the second terminal 72.

### Configuration of Third Terminals 73

As shown in FIG. 4, the four third terminals 73 are provided at positions further in the second direction Y1 than the two second terminals 72. Each third terminal 73 is a terminal for signal line. Each third terminal 73 is accommodated into the third terminal accommodating portion 43 of the housing body 30 along the first direction X1. A wire 23 is connected to each third terminal 73. Each third terminal 73 is, for example, directly connected to the wire 23 by crimping, resistance welding or the like. The wire 23 extends in the first opposite direction X2 from the third terminal 72. Although not shown, each third terminal 73 is connected to a mating terminal of the external connector described above.

### Configuration of Fourth Terminal 74

As shown in FIG. 6, the one fourth terminal 74 is provided between the two first terminals 71. The fourth terminal 74 is a terminal for ground line. The fourth terminal 74 is formed to be thicker in diameter than the first terminals 71. The fourth terminal 74 is accommodated into the fourth terminal accommodating portion 44 of the housing body 30 along the first direction X1. The busbar 24 is connected to the fourth terminal 74. The busbar 24 is connected to the fourth terminal 74 by bolt-nut fastening using a nut N2. A mating terminal T2 is electrically connected to the fourth terminal 74. The mating terminal T2 is, for example, a terminal of the external connector described above. By connecting the external connector to the charging inlet 11, the mating terminal T2 is connected to the fourth terminal 74.

### Configuration of Retainer 60

As shown in FIG. 2, the retainer 60 is fixed to the housing body 30 to close an opening of the mounting portion 32. The retainer 60 is assembled with the housing body 30 along the first direction X1. The retainer 60 is fixed to the housing body 30 by bolts B2.

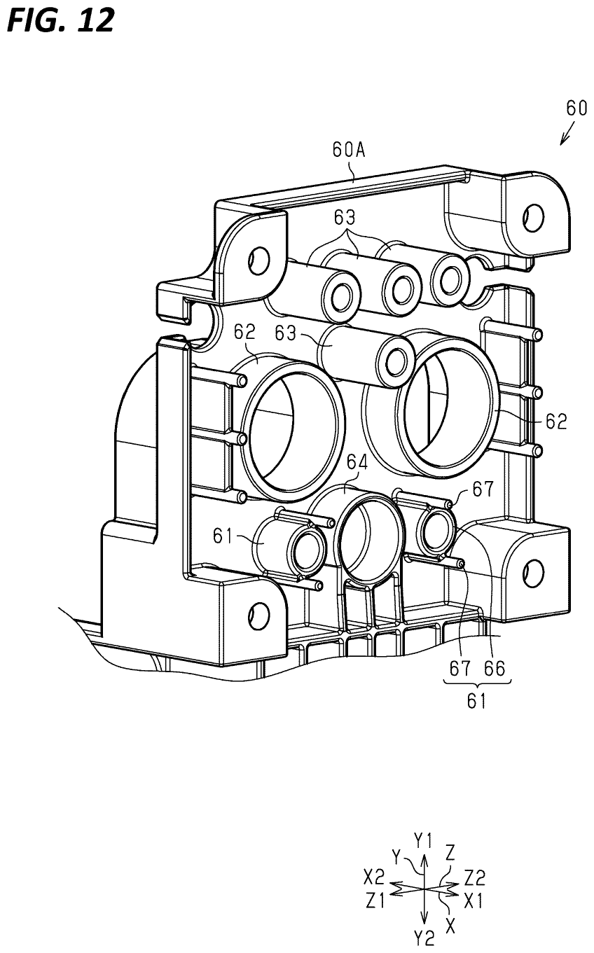

As shown in FIG. 12, the retainer 60 includes a base portion 60A, terminal holding portions 61 for holding the first terminals 71 (see FIG. 4) and terminal holding portions 62 for holding the second terminals 72 (see FIG. 4). The retainer 60 includes terminal holding portions 63 for holding the third terminals 73 (see FIG. 4) and a terminal holding portion 64 for holding the fourth terminal 74 (see FIG. 4). The retainer 60 of this embodiment includes two terminal holding portions 61, two terminal holding portions 62, four terminal holding portions 63 and one terminal holding portion 64. Each of the terminal holding portions 61, 62, 63 and 64 projects in the first direction X1 from the base portion 60A. Each of the terminal holding portions 61, 62, 63 and 64 is formed into a tubular shape as a whole.

Each terminal holding portion 61 includes a tubular portion 66 and pressing portions 67 projecting further in the first direction X1 than an end surface in the first direction X1 of the tubular portion 66. The tubular portion 66 is formed into a hollow cylindrical shape. The pressing portion 67 is formed into a column shape.

As shown in FIG. 7, the tubular portion 66 is inserted inside the first accommodation tube portion 45 of the first terminal accommodating portion 41. Each pressing portion 67 is provided to face the recess 47. Each pressing portion 67 is insertable into the recess 47 along the first direction X1. The tip surface of each pressing portion 67, i.e. an end surface in the first direction X1 of each pressing portion 67, can contact an end surface in the first opposite direction X2 of the projecting piece 95 of the connection terminal 90. If the retainer 60 is assembled with the housing body 30, the projecting pieces 95 of the connection terminal 90 are sandwiched by the tip surfaces of the pressing portions 67 and the bottom surfaces of the recesses 47 in an insertion direction of the first terminal 71 into the housing body 30 (here, the first direction X1). In this way, movements of the connection terminal 60 including the projecting pieces 95 in the first direction X1 and the first opposite direction X2 are restricted.

### Functions and Effects of Embodiment

Next, functions and effects of this embodiment are described.
(1) The connector 20 is provided with the housing 21 including the housing body 30 and the retainer 60 mounted on the housing body 30, and the tubular first terminal accommodating portions 41 provided in the housing body 30. The connector 20 is provided with the first terminals 71 for signal line to be inserted into the first terminal accommodating portions 41 along the first direction X1, the connection terminals 90 screw-connected to the first terminals 71 and the wires 22 electrically connected to the connection terminals 90. The first terminal 71 is structured such that the first connecting portion 81 connected to the connection terminal 90 and the second connecting portion 82 to be connected to the mating terminal T1 are provided side by side along the first direction X1. The connection terminal 90 is structured such that the terminal connecting portion 92 connected to the first connecting portion 81 and the wire connecting portion 91 connected to the wire 22 are provided side by side along the orthogonal direction orthogonal to the first direction X1.

According to this configuration, the terminal connecting portion 92 of the connection terminal 90 is screw-fastened to the first connecting portion 81 of the first terminal 71, and the terminal connecting portion 92 and the wire connecting portion 91 are provided side by side along the orthogonal direction orthogonal to the first direction X1. The wire 22 is connected to the wire connecting portion 91. In this way, the wire 22 can be electrically connected to the first connecting portion 81 of the first terminal 71 through the connection terminal 90. Further, since the wire 22 is connected to the wire connecting portion 91 provided side by side with the terminal connecting portion 92 in the orthogonal direction, that wire 22 can be routed to extend in the orthogonal direction orthogonal to the insertion direction of the first terminal 71 into the first terminal accommodating portion 41 (i.e. the first direction X1). In this way, the enlargement of the first terminal 71 and the wire 22 in the first direction X1 and the first opposite direction X2 can be suppressed. Thus, the connector 20 can be reduced in size in the first direction X1 and the first opposite direction X2, for example, as compared to the case where a wire directly connected to the first connecting portion 81 without via the connection terminal 90 is routed to extend in the first opposite direction X2.
(2) The first connecting portion 81 includes the base portion 84 and the bolt portion 85 projecting in the first opposite direction X2 from the base portion 84. The terminal connecting portion 92 includes the body portion 93 and the bolt hole 94 penetrating through the body portion 93 in the first direction X1. The terminal connecting portion 92 is electrically connected to the first connecting portion 81 by fastening the nut N1 to the bolt portion 85 inserted through the bolt hole 94.

According to this configuration, the terminal connecting portion 92 and the first connecting portion 81 can be electrically connected to each other by bolt-nut fastening using the bolt portion 85 of the first connecting portion 81 and the nut N1. Further, since the first connecting portion 81 is provided with the bolt portion 85, it can be suppressed that a transverse cross-sectional area of the first connecting portion 81, i.e. a conductor cross-sectional area of the first connecting portion 81, is reduced. That is, a reduction in the conductor cross-sectional area of the first connecting portion 81 can be suppressed as compared to the case where a bolt hole, through which a bolt is inserted, is formed in the first connecting portion 81.
(3) The terminal connecting portion 92 includes the projecting pieces 95 projecting outward from the outer peripheral surface of the body portion 93. The retainer 60 is assembled with the housing body 30 along the first direction. The retainer 60 includes the terminal holding portions 61 for holding the first terminals 71. The terminal holding portion 61 includes the tubular portion 66 to be fit into the first terminal accommodating portion 41 and the pressing portions 67 projecting further in the first direction X1 than the end surface in the first direction X1 of the tubular portion 66 and capable of contacting the projecting pieces 95. The projecting pieces 95 are sandwiched by the housing body 30 and the pressing portions 67 in the first direction X1.

According to this configuration, the projecting pieces 95 of the terminal connecting portion 92 are sandwiched and held by the housing body 30 and the pressing portions 67 of the retainer 60 in the first direction X1. Movements of the projecting pieces 95 in the first direction X1 and the first opposite direction X2 can be suitably restricted by these housing body 30 and pressing portions 67. As a result, position shifts of the connection terminal 90 including the projecting pieces 95 and the first terminal 71 connected to the connection terminal 90 in the first direction X1 and the first opposite direction X2 can be suitably suppressed. Further, by providing the projecting pieces 95, the enlargement of the entire terminal connecting portion 92 can be suppressed. In this way, a reduction in separation distance to the adjacent terminal (e.g. the fourth terminal 74) can be suppressed. Therefore, the occurrence of a problem that a desired distance cannot be ensured as the separation distance between the first terminal 71 and the fourth terminal 74 can be suitably suppressed.
(4) The first terminal accommodating portion 41 includes the recesses 47 recessed in the first direction X1 from the end surface in the first opposite direction X2 of the first terminal accommodating portion 41. The projecting pieces 95 are insertable into the recesses 47 along the first direction X1. The pressing portions 67 are insertable into the recesses 47 along the first direction X1. The projecting pieces 95 are sandwiched by the bottom surfaces of the recesses 47 and the pressing portions 67 in the first direction X1.

According to this configuration, the projecting pieces 95 of the terminal connecting portion 92 are sandwiched and held by the bottom surfaces of the recesses 47 and the pressing portions 67 of the retainer 60 in the first direction X1. Movements of the projecting pieces 95 in the first direction X1 and the first opposite direction X2 can be suitably restricted by the bottom surfaces of the recesses 47 and the pressing portions 67. As a result, position shifts of the connection terminal 90 and the first terminal 71 in the first direction X1 and the first opposite direction X2 can be suitably suppressed.
(5) The terminal connecting portion 92 includes the two projecting pieces 95. The bolt hole 94 is provided in the center of the body portion 93 in a plan view in the first direction X1. The two projecting pieces 95 are provided on the both sides of the bolt hole 94 and project in the directions opposite to each other.

According to this configuration, each of the two projecting pieces 95 provided on the both sides of the bolt hole 94 provided in the center of the body portion 93 is sandwiched and held by the housing body 30 and the pressing portion 67 of the retainer 60. In this way, movements of the two projecting pieces 95 in the first direction X1 and the first opposite direction X2 can be suitably restricted. Therefore, movements of the connection terminal 90 including the two projecting pieces 95 in the first direction X1 and the first opposite direction X2 can be stably restricted.
(6) The body portion 93 is formed to have a circular planar shape when viewed in the first direction X1. The projecting pieces 95 are formed to project radially outwardly of the body portion 93 from the outer peripheral surface of the body portion 93. According to this configuration, the first connecting portion 81 of the first terminal 71 and the wire 22 can be electrically connected to each other through the connection terminal 90, which is a round terminal. Further, the enlargement of the entire terminal connecting portion 92 in a radial direction can be suppressed by providing the projecting pieces 95.
(7) The housing body 30 includes the wire accommodating portions 50 for accommodating the wires 22. The wire accommodating portion 50 is formed to communicate with the first terminal accommodating portion 41. The wire accommodating portion 50 includes the wire holding projections 54 projecting inward from the inner surface of the wire accommodating portion 50. The width of the wire accommodating portion 50 in the part formed with the wire holding projections 54 is smaller than the outer diameter of the wire 22.

According to this configuration, the wire 22 is press-fit (specifically, lightly press-fit) into the wire accommodating portion 50 in the part formed with the wire holding projections 54. In this way, a movement of the wire 22 inside the wire accommodating portion 50 can be suitably restricted.
(8) The wire holding projection 54 is formed to extend in the first opposite direction X2 from the bottom surface of the wire accommodating portion 50. Thus, the wire 22 can be suitably held in a bottom part of the wire accommodating portion 50 by being lightly press-fit into the wire accommodating portion 50 in the part formed with the wire holding projections 54. In this way, the lift-up of the wire 22 such as during the assembly of the connector 20 can be suitably suppressed.
(9) The connector 20 is provided with the tubular second terminal accommodating portions 42 provided in the housing body 30, the second terminals 72 for power line to be inserted into the second terminal accommodating portions 42 along the first direction X1, and the busbars 25 electrically connected to the second terminals 72. The first terminals 71 are provided at positions overlapping the busbars 25 in a plan view in the first direction X1.

According to this configuration, the first terminals 71 are provided to overlap the busbars 25 to be connected to the second terminals 72 in the plan view in the first direction X1. At this time, since the enlargement of the first terminals 71 and the wires 22 in the first direction X1 can be suppressed, the interference of the first terminals 71 and the wires 22 with the busbars 25 can be suitably suppressed.

### Modifications

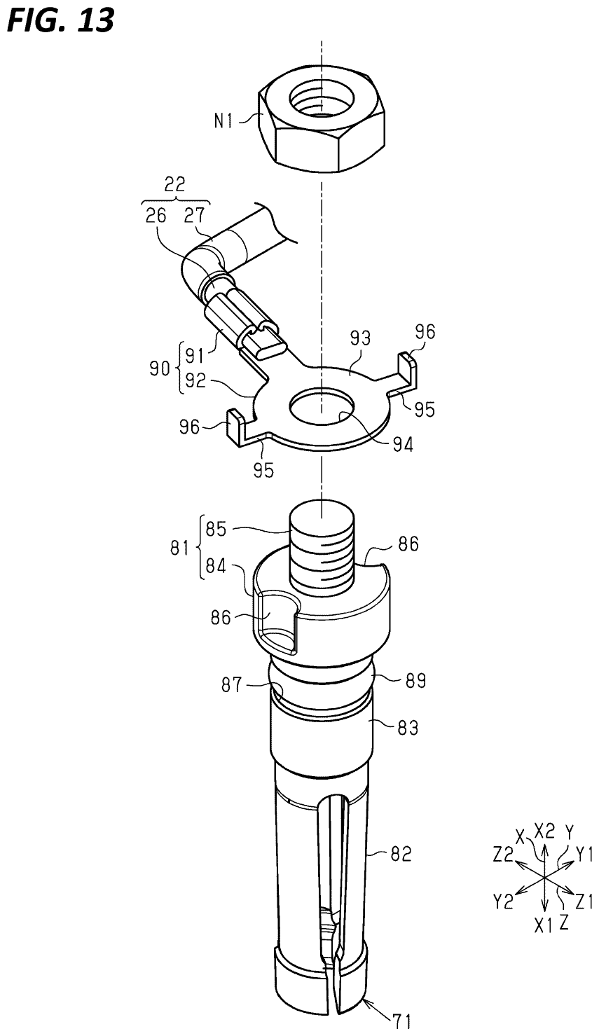

The above embodiment can be modified and carried out as follows. The above embodiment and the following modifications can be carried in combination with each other without technically contradicting.
The structure of the connection terminal 90 in the above embodiment can be changed as appropriate.
The structure of the projecting piece 95 can be changed as appropriate.
For example, as shown in FIG. 13, a projecting portion 96 projecting in the first opposite direction X2 may be provided on the tip of each projecting piece 95. The projecting portion 96 is in the form of a plate. The projecting piece 95 in this case is formed into an L shape as a whole.
The number of the projecting pieces 95 may be changed. For example, the number of the projecting pieces 95 may be changed to one or three or more.
Although the body portion 93 is formed to have a circular planar shape in the above embodiment, there is no limitation to this. The planar shape of the body portion 93 may be an arbitrary shape other than the circular shape, for example, a polygonal shape or an elliptical shape.
The structure of the first terminal 71 in the above embodiment can be changed as appropriate.
Although the first connecting portion 81 of the first terminal 71 is provided with the bolt portion 85 in the above embodiment, the first connecting portion 81 may be provided with a bolt hole. In this case, the bolt hole is, for example, provided in the base portion 84. By inserting a bolt through the bolt hole 94 of the terminal connecting portion 92 and fastening the bolt into the bolt hole provided in the base portion 84 with the terminal connecting portion 92 of the connection terminal 90 placed on the base portion 84, the first connecting portion 81 and the terminal connecting portion 92 are screw-fastened.
The cut portions 86 of the base portion 84 may be omitted.
The accommodation groove 87 of the coupling portion 83 may be omitted.
The sealing member 89 may be omitted.
The coupling portion 83 may be omitted. The first terminal 71 in this case is structured such that the first connecting portion 81 and the second connecting portion 82 are provided side by side along the first direction X1.
The structure of the third terminal 73 in the above embodiment can be changed as appropriate. For example, the structure of the third terminal 73 may be changed to a structure similar to that of the first terminal 71.
The structure of the housing body 30 in the above embodiment can be changed as appropriate.
The wire holding projection 54 in the wire accommodating portion 50 may be constituted by either one of the first and second projections 55, 56.
The number of the wire holding projections 54 in the above embodiment may be changed.
The wire holding projections 54 may be omitted.
The structure of the retainer 60 in the above embodiment can be changed as appropriate.
The number of the first terminals 71 in the above embodiment may be changed.
The number of the second terminals 72 in the above embodiment may be changed.
The number of the third terminals 73 in the above embodiment may be changed.
The number of the fourth terminals 74 in the above embodiment may be changed.
The embodiment disclosed this time should be considered illustrative in all aspects, rather than restrictive. The scope of the present invention is represented not by the above meaning, but by claims, and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing including a housing body and a retainer mounted on the housing body;
a tubular first terminal accommodating portion provided in the housing body;
a first terminal for signal line to be inserted into the first terminal accommodating portion along a first direction;
a connection terminal screw-fastened to the first terminal; and
a wire electrically connected to the connection terminal,
the first terminal being structured such that a first connecting portion connected to the connection terminal and a second connecting portion to be connected to a mating terminal are provided side by side along the first direction, and
the connection terminal being structured such that a terminal connecting portion connected to the first connecting portion and a wire connecting portion connected to the wire are provided side by side along an orthogonal direction orthogonal to the first direction.

2. The connector of claim 1, wherein:
the first connecting portion includes a base portion and a bolt portion projecting in a first opposite direction opposite to the first direction from the base portion,
the terminal connecting portion includes a body portion and a bolt hole penetrating through the body portion in the first direction, and
the terminal connecting portion is electrically connected to the first connecting portion by fastening a nut to the bolt portion inserted through the bolt hole.

3. The connector of claim 2, wherein:
the terminal connecting portion includes a projecting piece projecting outward from an outer peripheral surface of the body portion,
the retainer is assembled with the housing body along the first direction,
the retainer includes a terminal holding portion for holding the first terminal,
the terminal holding portion includes a tubular portion to be fit into the first terminal accommodating portion and a pressing portion projecting further in the first direction than an end surface in the first direction of the tubular portion and capable of contacting the projecting piece, and
the projecting piece is sandwiched by the housing body and the pressing portion in the first direction.

4. The connector of claim 3, wherein:
the first terminal accommodating portion includes a recess recessed in the first direction from an end surface in the first opposite direction of the first terminal accommodating portion,
the projecting piece is insertable into the recess along the first direction,
the pressing portion is insertable into the recess along the first direction, and
the projecting piece is sandwiched by a bottom surface of the recess and the pressing portion in the first direction.

5. The connector of claim 3, wherein:
the terminal connecting portion includes at least two projecting pieces,
the bolt hole is provided in a center of the body portion in a plan view in the first direction, and
the two projecting pieces are provided on both sides of the bolt hole and project in directions opposite to each other.

6. The connector of claim 3, wherein:
the body portion is formed to have a circular planar shape when viewed in the first direction, and
the projecting piece is formed to project radially outwardly of the body portion from the outer peripheral surface of the body portion.

7. The connector of claim 1, wherein:
the housing body includes a wire accommodating portion for accommodating the wire,
the wire accommodating portion is formed to communicate with the first terminal accommodating portion,
the wire accommodating portion includes a wire holding projection projecting inward from an inner surface of the wire accommodating portion, and
a width of the wire accommodating portion in a part formed with the wire holding projection is smaller than an outer diameter of the wire.

8. The connector of claim 1, comprising:
a tubular second terminal accommodating portion provided in the housing body;
a second terminal for power line to be inserted into the second terminal accommodating portion along the first direction; and
a busbar electrically connected to the second terminal,
the first terminal being provided at a position overlapping the busbar in a plan view in the first direction.
